(19) United States
(12) Patent Application Publication
(10) Pub. No.: US 2022/0017778 A1
(43) Pub. Date: Jan. 20, 2022

(54) Methods of Treating Inorganic Surfaces

(71) Applicant: ZYDEX INC., Morrisville, NC (US)

(72) Inventors: Mikhil Ranka, Morrisville, NC (US); Moulik Ranka, Morrisville, NC (US)

(21) Appl. No.: 17/419,941

(22) PCT Filed: Dec. 30, 2019
(86) PCT No.: PCT/US19/68923

§ 371 Date: Jun. 30, 2021

Related U.S. Application Data
(60) Provisional application No. 62/787,221, filed on Dec. 31, 2018.

(51) Int. Cl. C09D 183/06; C09D 5/00; C04B 41/49

(52) U.S. Cl. CPC C09D 183/06; C04B 41/4922; C09D 5/00

(57) ABSTRACT

Methods of treating inorganic surfaces are provided. The methods include a step of applying an aqueous-based composition to the inorganic surface, in which the aqueous-based composition includes at least one transesterified alkoxy silane. The methods impart water resistance to the inorganic surface. After application, a treated inorganic surface may exhibit a long term water repellant property due to the formation of a hydrophobic layer upon drying of the aqueous-based composition

### CROSS REFERENCE TO RELATED APPLICATION

This application claims priority to U.S. application No. 62/787,221 filed Dec. 31, 2018, the entire contents of which are hereby incorporated by reference in its entirety.

### TECHNICAL FIELD

Embodiments of the presently-disclosed invention relate generally to methods of treating inorganic surfaces including a step of applying an aqueous-based composition to the inorganic surface, in which the aqueous-based composition includes at least one transesterified alkoxy silane. Embodiments of the presently-disclosed invention also generally relate to treated inorganic surface that exhibit a long term water repellant property.

### BACKGROUND

As discussed in U.S. Pat. No. 5,073,195, application of organosilicon compounds to surfaces for water proofing is generally known in the art. For instance, the use of organosilanes such as alkyltrialkoxy compounds for imparting water resistance has been known for at least 30 years. Traditionally, application of these compounds was carried out in flammable solvents such as ethanol, methanol, and various liquid hydrocarbons. During application, volatile organic compounds (VOC) were heavily emitted. Due to these problems, significant efforts were employed to formulate a nonflammable composition for imparting water resistance to masonry and concrete surfaces.

The first attempted approach included various water emulsions containing organosilicon compounds. However, these formulations failed to provide water resistance comparable to the solvent based compositions. In recognition of the shortcomings associated with such water emulsion formulations, additional formulations were developed to make alkyltrialkoxy silanes water soluble. For instance, U.S. Pat. Nos. 5,209,775, 5,300,327, 5,421,866, and 5,695,551 are directed to formulations that utilize water soluble amino and quaternary ammonium organosilanes along with alkyltrialkoxysilanes of the traditional formulations. In this regard, the intent of these formulations was to exploit the soluble organosilanes to solubilize the alkyltrialkoxysilanes, which provided the water repellant characteristic.

While providing an ecological improvement over solvent-based treatments, the water based formulations do not compare well with existing solvent-base silanes, silane/siloxanes combinations or siloxanes in terms of stability, penetration depth, and the beading effect of the treated substrate. This shortcoming is primarily due to the fact that the water-soluble nature of the coupling agents limit the extent of hydrophobicity that is developed by the formulation.

Therefore, there remains a need for an aqueous water proofing treatment capable of providing at least equally efficient water resistance as treatments utilizing solvent-based compositions while being ecologically friendly in terms of use.

### SUMMARY OF INVENTION

One or more embodiments of the invention may address one or more of the aforementioned problems. Certain embodiments according to the invention provide methods of treating inorganic surfaces are provided. The methods include a step of applying an aqueous-based composition to the inorganic surface, in which the aqueous-based composition includes at least one transesterified alkoxy silane. In accordance with certain embodiments of the invention, the methods impart water resistance to the inorganic surface. After application, a treated inorganic surface may exhibit a long term water repellant property, for example, due to the formation of a hydrophobic layer upon drying of the aqueous-based composition.

In another aspect, the present disclosure provides a treated inorganic surface exhibiting water repellency. In accordance with certain embodiments of the invention, the treated surface may comprise a hydrophobic layer bonded to reactive sites on the inorganic surface. In accordance with certain embodiments of the invention, the hydrophobic layer may be a hydrosylate (i.e., a product of hydrolysis) of one or more compounds described and disclosed herein.

### DETAILED DESCRIPTION

The invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise.

The presently-disclosed invention provides methods of treating inorganic surfaces that provide or impart one or more of the following desirable features for providing long term hydrophobicity on inorganic substrates: (1) application of a safer and environmentally acceptable aqueous-based composition (e.g., an aqueous solution); (2) imparting molecular level hydrophobicity; and (3) providing penetration into the inorganic material equivalent to solvent-based compositions. In this regard, the present invention also provides a treated inorganic surface exhibiting water repellency having a particularly high level of water exclusion percentage (e.g., from 80% to 100%). In accordance with certain embodiments of the invention, the treated surface may comprise a hydrophobic layer bonded to reactive sites on the inorganic surface. In accordance with certain embodiments of the invention, the hydrophobic layer may be a hydrosylate (i.e., a product of hydrolysis) of one or more compounds described and disclosed herein.

The term “aqueous-based composition”, as used herein, may comprise a composition utilizing water as the main solvent and/or carrier. In accordance with certain embodiments of the invention, an “aqueous-based composition” composition may comprise less than 10% by weight, such less than 5% by weight, or less than 1% by weight of an organic solvent. In accordance with certain embodiments of the invention, an “aqueous-based composition” composition may be devoid of an organic solvent. In accordance with certain embodiments of the invention, an “aqueous-based composition” may comprise a solution, dispersion, colloidal suspension, or a sol-gel.

Certain embodiments according to the invention provide methods of treating inorganic surfaces are provided. The methods include a step of applying an aqueous-based composition to the inorganic surface, in which the aqueous-based composition includes at least one transesterified alkoxy silane. In accordance with certain embodiments of the invention, the methods impart water resistance to the inorganic surface. After application, a treated inorganic surface may exhibit a long term water repellant property, for example, due to the formation of a hydrophobic layer upon drying of the aqueous-based composition.

As discussed throughout the present disclosure, a variety of hydroxyl-containing compounds (e.g., simple hydrophilic alcohols including monoehtylene glycol (MEG), diethylene glycol (DEG), glycerol, sorbitol, dimethylolpropionic acid, etc.) may be used to swap out/exchange one or more of the silane-alkoxy groups of traditional non-water soluble organosilane waterproofing agents with a functional moiety (e.g., one or more hydroxyl groups) that imparts a more polar and/or water soluble nature to the resulting transesterified organosilane, in which the resulting transesterified organosilane may have enhanced water solubility. In accordance with certain embodiments of the invention, the enhanced hydrophilic nature of, for example, the transesterified alkyltrialkoxy silanes enable them to serve as waterproofing agents or be used as part of a formulation where they serve as the water soluble coupling agent to carry less soluble silane or siloxanes into water stably. In this regard, for example, the transesterified alkoxy silanes in accordance with certain embodiments of the invention, may be used exclusively on their own or formulated with traditional waterproofing compounds that are not water soluble (or adequately water soluble for providing adequate penetration depth into a surface to be treated).

For example, methyltrimethoxysilane (MTMS) in insoluble in water, but when transesterified with monoethyleneglycol (MEG) a resulting compound (i.e., transesterified alkoxy silane) is fully water soluble in all proportions and useful as a standalone waterproofing compound. Alternatively, due to the resulting compound's (i.e., transesterified alkoxy silane) highly water soluble nature, it can help solubilize traditional water insoluble waterproofing compounds, such as propyltrimethoxysilane and isobutyltrimethoxysilane.

In accordance with certain embodiments of the invention, it has been very surprisingly been found that the resulting transesterified alkoxy silanes (e.g., transesterified alkyltrialkoxysilanes) possess sufficient water solublity such that aqueous compositions comprising them can be stably formulated and used to treat inorganic surfaces to impart water repellency. This is surprising since the polar alcohols (such as MEG or DEG) do not cause wetting of the substrate post hydrolysis.

Furthermore, the transesterified compounds may be in liquid form and therefore can also be shipped as 100 percent actives, and liberate non-flammable alcohols such as MEG or DEG instead of methanol or ethanol. Their non-ionic nature also makes them deeply penetrative into the pores of inorganic surfaces, such as rocks, stones, masonry, concrete, and cement such that the depth of waterproofing is the same as that of depth of water penetration. Additionally, the polar nature of alcohols, such as MEG or DEG, increases the boiling point of the transesterified alkoxy silanes (e.g., transesterified alkyltrialkoxysilanes) substantially making them non-volatile under normal use conditions. In this regard, all of these factors contribute to ease and safety of use in the field.

As noted above, traditional organosilane waterproofing agents are not water soluble and are highly flammable. Typical examples include methytrimethoxy silane (MTMS), propyltrimethoxy silane (PTMO), isobutyltrimethoxy silane (IBTMO), octadecyltrimethoxy silane (OTMO). Such traditional organosilane waterproofing agents also have relatively low boiling points making them quite hazardous and difficult to handle. In accordance with certain embodiments of the invention, however, such traditional non-water soluble organosilane waterproofing agents may be modified by a transesterification reaction, which swaps out, for example, the methoxy or ethoxy groups on a typical alkoxy silane for hydrophilic compounds that have hydroxyl groups. It is well established that in organosilane chemistry, for instance, that a silane-alkoxy group (i.e., Si—OR) is known as a silane ester and that a transesterification reaction is an exchange reaction in which two different alkoxy groups are exchanged with each other. For example, if Si—OCH₃ is reacted with HOCH₂CH₂OH the methoxy group is exchanged with mono ethylene glycol resulting in the formation of Si—OCH₂CH₂OH by the transesterification reaction. As discussed in more detail below, a variety of hydroxyl-containing compounds (e.g., simple hydrophilic alcohols including monoehtylene glycol (MEG), diethylene glycol (DEG), glycerol, sorbitol, dimethylolpropionic acid etc.) may be used to swap out/exchange one or more of the silane-alkoxy groups of traditional non-water soluble organosilane waterproofing agents with a functional moiety (e.g., one or more hydroxyl groups) that imparts a more polar and/or water soluble nature to the resulting transesterified organosilane, in which the resulting transesterified organosilane may have a water solubility as described herein.

Transesterified alkoxy silanes, in accordance with certain embodiments of the invention, may comprise a solubility in water of at least about 5 grams per Liter (g/L) of water at a temperature of 20° C., such as at least about 10 g/L, at least about 20 g/L, or at least about 50 g/L. In accordance with certain embodiments of the invention, the transesterified alkoxy silanes may comprise a solubility in water at 20° C. from at least about any of the following: 5, 10, 15, 20, 25, 30, 35, 40, 45, 50, 55, and 60 g/L and/or at most about 150, 140, 130, 120, 110, 100, 90, 80, 70, and 60 g/L.

In accordance with certain embodiments of the invention, the transesterified alkoxy silane(s) may comprise from about 0.01 to about 20 weight percent of the aqueous-based composition, such as from at least about any of the following: 0.01, 0.1, 0.25, 0.5, 0.75, 1, 2, 4, 5, 6, 8, 10, and 12 weight percent of the aqueous-based composition and/or at most about 20, 18, 16, 15, 14, 12, 10, and 8 weight percent of the aqueous-based composition.

In accordance with certain embodiments of the invention, the transesterified alkoxy silanes may, for example, have a structure according to Formula (1):

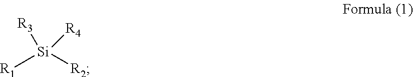

wherein R₁ comprises a substituted or non-substituted hydrocarbon radical; R₂ comprises a first hydroxyl-containing alkoxy radical; R₃ comprises an alkoxy radical or a second hydroxyl-containing alkoxy radical; and R₄ comprises an alkoxy radical or a third hydroxyl-containing alkoxy radical. In accordance with certain embodiments of the invention, the first hydroxyl-containing alkoxy radical, the second hydroxyl-containing alkoxy radical, the third hydroxyl-containing may be identical. Alternatively, the first hydroxyl-containing alkoxy radical may be different than at least the second hydroxyl-containing alkoxy radical. In accordance with certain embodiments of the invention, Ri comprises an alkyl radical. For example, the alkyl radical may comprise a linear alkyl radical, a branched alkyl radical, or a cycloalkyl radical including from one to thirty carbon atoms (e.g., at most about 30, 25, 20, 18, 16, 14, 12, 10, and 8 carbon atoms and/or at least about 1, 2, 3, 4, 5, 6, 7, 8, 9, 10, and 12 carbon atoms). In accordance with certain embodiments of the invention, Ri may comprise a substituted hydrocarbon radical having one or more of a halide atom, a nitrogen atom, or an oxygen atom.

In accordance with certain embodiments of the invention, hydroxyl-containing alkoxy radicals of the transesterified alkoxy silane according to Formula (1) comprises —(OCH₂CH₂)ₐOH where ‘a’ has a value of 1 through 10 (e.g., 1, 2, 3, 4, 5 ,6, 7, 8, 9, or 10), —[OC₃H₆]_{b}OH where ‘b’ has a value of 1 through 10 (e.g., 1, 2, 3, 4, 5 ,6, 7, 8, 9, or 10), or [C₃H₇O₃], [C₆H₁₃O₆], [C₅H₁₁O₄] and [C₄H₆O₃]. The transesterified alkoxy silane, in accordance with certain embodiments of the invention, may comprise the first hydroxyl-containing alkoxy radical and the second hydroxyl-containing alkoxy radical, in which the first hydroxyl-containing alkoxy radical and the second hydroxyl-containing alkoxy radical each independently comprise —(OCH₂CH₂)ₐOH where ‘a’ has a value of 1 through 10 (e.g., 1, 2, 3, 4, 5 ,6, 7, 8, 9, or 10), [OC₃H₆]_{b}OH where ‘b’ has a value of 1 through 10 (e.g., 1, 2, 3, 4, 5 ,6, 7, 8, 9, or 10), or [C₃H₇O₃], or [C₆H₁₃O₆], or [C₅H₁₁O₄], or [C₄H₆O₃].

Aqueous-based compositions in accordance with certain embodiments of the invention may additionally comprise at least one water soluble non-ionic organosilane that is inherently or naturally water soluble organosilane. In this regard, aqueous-based compositions in accordance with certain embodiments of the invention may comprise both transesterified alkoxy silane(s) and inherently or naturally water soluble organosilanes. In accordance with certain embodiments of the invention, the aqueous-based compositions may comprise one or more transesterified alkoxy silane and/or one or more inherently or naturally water soluble ogranosilanes, in which one or more (or all) of the compounds comprise a solubility in water of at least about 5 grams per Liter of water at a temperature of 20° C., such as at least about 10 g/L, at least about 20 g/L, or at least about 50 g/L. In accordance with certain embodiments of the invention, one or more (or all) of the compounds may comprise a solubility in water at 20° C. from at least about any of the following: 5, 10, 15, 20, 25, 30, 35, 40, 45, 50, 55, and 60 g/L and/or at most about 150, 140, 130, 120, 110, 100, 90, 80, 70, and 60 g/L.

In accordance with certain embodiments of the invention, the at least one water soluble non-ionic organosilane may comprise a structure according to the following Formula (2):

A₍₄₋ₙ₎SiYₙ; Formula (2):

wherein ‘A’ comprises a monovalent organic radical, such as a monovalent organic radical including at least amine functionality, ‘Y’ comprises a hydrolyzable radical, and n is 1, 2, or 3. In accordance with certain embodiments of the invention, ‘A’ comprises an alkyl or aryl radical. ‘Y’, in accordance with certain embodiments of the invention, may comprise radicals that hydrolyze in the presence of water and include acetoxy radicals and alkoxy radicals with 1 to 6 carbon atoms. In this regard, in accordance with certain embodiments of the invention, the at least one water soluble non-ionic organosilane may comprise an amino-functional silane or a bis-aminofunctional silane. For example, the amino-functional silane may comprise N-(2-aminoethyl)-3-aminopropyltrimethoxysilane, N-aminoethylaminomethyl)phenyltrimethoxysilane, N-(2-aminoethyl)-3-aminopropyltris(2-ethylhexoxy)-silane, 3-aminopropyltrimethoxysilane, trimethoxysilyl-propyldiethylenetriamine, bis(2-hydroxyethyl)-3-aminopropyltrimethoxysilane or any combinations thereof.

In accordance with certain embodiments of the invention, the aqueous-based composition comprises at least one transesterified alkoxy silane and at least one inherently or naturally water soluble non-ionic organosilane as disclosed herein. The aqueous-based composition, for example, may comprise an aqueous solution or aqueous dispersion even if the composition includes at least one ionic organosilicon compound (as discussed below). For instance, the aqueous-based composition may comprise less than 10% by weight, such less than 5% by weight, or less than 1% by weight of an organic solvent. The aqueous-based composition, in accordance with certain embodiments of the invention, may be devoid of an organic solvent.

Aqueous-based compositions, in accordance with certain embodiments of the invention, may comprise a first weight ratio, calculated on a dry basis, between the at least one transesterified alkoxy silane and the at least one inherently or naturally water soluble non-ionic organosilane comprising from about 50:1 to about 1:1.

In accordance with certain embodiments of the invention, the aqueous-based composition may further comprise at least one ionic organosilicon compound comprising a cationic organosilicon compound (e.g., a combination of at least one transesterified alkoxy silane and at least one ionic organosilicon compound,or the combination of at least one transesterified alkoxy silane, a least one ionic organosilicon compound, and at least one non-ionic water soluble silane).

In accordance with certain embodiments of the invention, the aqueous-based composition may comprise a second weight ratio between the at least one transesterified alkoxy silane to the at least one ionic organosilicon compound comprising from about 98:2 to about 2:98; such as at most about any of the following: 95:5, 90:10, 85:15, 80:20, 75:25, 70:30, 65:45. 60:40, 55:45, 50:50, 45:55, and 40:60 and/or at least about any of the following: 2:98. 5:95, 10:90, 15:85, 20:80, 25:75, 30:70, 35:65, 40:60, 45:55, 50:50, 55:45, and 60:40.

In accordance with certain embodiments of the invention, the transesterified organosilanes (i.e., the resulting transesterified non-ionic organosilanes) exhibit a sufficient level of water solubility such that when provided in combination (e.g., in an aqueous liquid composition) with an ionic organosilane (e.g., ionic organosilicon compound) good solubility of the overall liquid composition (e.g., aqueous mixture or dispersion) may be achieved. For example, the transesterified non-ionic organosilanes may comprise a sufficiently large water solubility, as discussed above, to be provided in liquid form (e.g., dissolved in an aqueous medium) and act as a solvent or carrier for the ionic organosilane (e.g., ionic organosilicon compound). For instance, the transesterified non-ionic organosilanes may act as a solvent or carrier for the ionic organosilane (e.g., ionic organosilicon compound) and facilitate a greater depth of penetration into and through the surface of the inorganic surface or substrate, which is typically anionic in nature, for the ionic organosilane (e.g., ionic organosilicon compound) that provides desirable water repellant properties to the inorganic surface or substrate to prevent ingress of water. As noted above, in accordance with certain embodiments of the invention, the aqueous-based composition may additionally or in the alternative comprise a naturally or inherently water soluble non-ionic organosilane. In this regard, deeper penetration of the inorganic surface or substrate by the aqueous-based composition may provide increased water repellency to the treated surface as well as increased water repellency deeper into the surface or substrate.

In accordance with certain embodiments of the invention, the aqueous-based compositions may be significantly non-ionic and substantial gains in penetration of the organosilanes into the inorganic surface or substrate may be realized. Furthermore, at least one transesterified alkoxy silane and/or the water soluble non-ionic organosilanes of aqueous-based compositions in accordance with certain embodiments of the invention may be substantially lower in molecular weight and have significantly higher molar densities per unit mass, which may further contribute to increased hydrophobicity in a substantial manner. In accordance with certain embodiments of the invention, for example, the molar density per unit mass of the at least one transesterified alkoxy silane and/or the water soluble non-ionic organosilanes may comprise from about 0.5 mol/kg to about 6 mol/kg, such as from at least about any of the following: 0.5, 0.6, 0.7, 0.8, 0.9, 1.0, 1.1, 1.2, 1.3, 1.4, and 1.5 mol/kg and/or at most about 6, 5.5, 5, 4.5, 4, 3.5, 3, 2.5, 2, 1.75, and 1.5 mol/kg. Additionally and as noted above, the at least one transesterified alkoxy silane and/or the water soluble non-ionic organosilanes may comprise a liquid and serve as a solvent or carrier for the ionic organosilicon compound (if present) of the compositions in accordance with certain embodiments of the invention.

In accordance with certain embodiments of the invention, the aqueous-based composition comprises may comprise at least one ionic organosilicon compound, such as a cationic organosilicon compound. The at least one ionic organosilicon compound may comprise a structure according to Formulae (3):

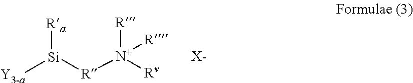

wherein in each formula of Formulae (3),

Y is an alkoxy radical or a hydroxyl-containing hydroxyl radical;

‘a’ has a value of 0, 1, or 2;

R′ is an alkyl radical, such as having 1, 2, 3, 4, 5, or 6 carbon atoms;

R″ is an alkylene group, such as having 1, 2, 3, 4, 5, or six carbon atoms;

R′″, R″″ are alkyl groups containing 1 to 22 carbon atoms, wherein at least one of R′″ and R″″ is larger than eight carbon atoms, —CH₂C₆H₅, —CH₂C₆H₅, —CH₂CH₂OH, —CH₂OH, and —(CH₂)ₓNHC(O)R^{vi} wherein x has a value of from two to ten and Rv is a perfluoroalkyl radical having one to twelve carbon atoms;

X is chloride, bromide, fluoride, iodide, acetate or tosylate;

In accordance with certain embodiments of the invention, the aqueous-based composition includes a cationic organosilicon compound comprising a structure according to Formula (4):

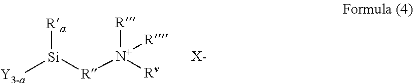

wherein Y is a methyl or ethyl alkoxy radical; ‘a’ has a value of zero; R″ is propylene; R′″ is methyl or ethyl; R″″ and R^{v} are identical or different alkyl groups containing from one to twenty-two carbon atoms, wherein at least one of R′″ and R″″ is larger is larger than eight carbon atoms; and X is a halide, acetate, or tosylate.

The cationic organosilicon compound, in accordance with certain embodiments of the invention, may comprises 3-(trimethoxysilyl)propyldimethyloctadecyl ammonium chloride, 3-(trimethoxysilyl)propylmethyldidecyl ammonium chloride, or 3-(trimethoxysilyl)propyldimethylhexadecyl ammonium chloride.

In accordance with certain embodiments of the invention, the at least one transesterified alkoxy silane may be present in the form of a hydrosylate. For instance, the at least one transesterified alkoxy silane may be present as a component within a hydrosylate product formed with one or more silicon atom-containing compound (e.g., hydrolysis product of (i) one or more transesterified alkoxy silane, (ii) one or more transesterified alkoxy silanes and one or more water soluble non-ionic organosilanes as described herein, (iii) one or more transesterified alkoxy silanes and one or more cationic organosilicon compound, (iv) one or more transesterified alkoxy silane and/or one or more water soluble non-ionic organosilanes and/or one or more cationic organosilicon compounds). In accordance with certain other embodiments of the invention, for instance, the at least one transesterified alkoxy silane alone or in combination with other Si-containing compounds, such as those disclosed herein, may be in the form of cohydrolysates with, for example, Tetraethylorthosilicate (TEOS) and/or Tetramethylorthosilcate (TMOS) and/or transesterified versions of Tetraethylorthosilicate (TEOS) and/or Tetramethylorthosilcate (TMOS). For example, the at least one transesterified alkoxy silane (e.g., transesterified triaalkoxyalkyl silanes) may be cohydrolysed with each other or with crosslinking organosilanes such as Tetraethylorthosilicate (TEOS) and/or Tetramethylorthosilicate (TMOS) to form, for example, a sol-gel silane coating that is water based yet water repellent. As noted above, TEOS and TMOS may also be present in transesterified form, such that that they too become water soluble as disclosed herein.

In accordance with certain embodiments of the invention, the use of the at least one transesterified alkoxy silane in combination with, for example, TEOS/TMOS (or their transesterified versions) is that the resulting coating advantageously forms a sol-gel organosilicon layer that imparts water repellency, even if the underlying substrate does not inherently have a high density of silanol groups to chemically bond. This beneficial property can be useful in the form of anti-corrosion coatings for steel and as water repellent coatings for wood as two basic examples. In this regard, such embodiments of the present invention also provide methods of treating non-inorganic (e.g., organic) surfaces or substrates as well as provide treated organic surfaces or substrates (e.g., wood).

The aqueous-based composition, in accordance with certain embodiments of the invention, may comprise the sum of the at least one transesterified alkoxy silane, the at least one water soluble non-ionic organosilane if present, and the at least one ionic organosilicon compound if present comprising from about 5% to about 100% dissolved and/or suspended solids by weight, such from at least about any of the following: 5, 10, 15, 20, 25, 30, 35, 40, 45, 50, 55, and 60% dissolved and/or suspended solids by weight and/or at most about 100, 95, 90, 85, 80, 75, 70, 65, and 60% dissolved and/or suspended solids by weight. In this regard, the % dissolved and/or suspended solids by weight may be determined by adding the weight of dry solids attributed to the sum of the at least one transesterified alkoxy silane, the at least one water soluble non-ionic organosilane if present, and the at least one ionic organosilicon compound if present in a given volume of aqueous-based composition, divided by the total weight of that volume of the aqueous-based composition multiplied by 100. Such embodiments, for example, may comprise a concentrate that can be easily shipped or transported to locations in need of such compositions without the added cost and difficulty of shipping undesirably large weights of solvents. In this regard, the concentrate may be diluted with water at the site of need to a desired % dissolved and/or suspended solids level for treating a surface (e.g., inorganic surface). In accordance with certain embodiments of the invention, the sum of the at least one transesterified alkoxy silane, the at least one water soluble non-ionic organosilane if present, and the at least one ionic organosilicon compound if present comprises from about 0.1% to about 10% dissolved and/or suspended solids by weight, such as from at least about any of the following: 0.1, 0.2, 0.25, 0.5, 0.75, 1, 1,25, 1.5, 1.75, 2.0, 2.25, 2.5, 2.75, 3.0, 3.25, 3.5, 3.75, and 4.0% dissolved and/or suspended solids by weight and/or at most about 5, 4.75, 4.5, 4.25, 4.0, 3.75, 3.5, 3.25, and 3% dissolved and/or suspended solids by weight. In this regard, the % dissolved and/or suspended solids by weight may be determined by adding the weight of dry solids attributed to the sum of the at least one transesterified alkoxy silane, the at least one water soluble non-ionic organosilane if present, and the at least one ionic organosilicon compound if present in a given volume of composition, divided by the total weight of that volume of the aqueous-based composition multiplied by 100. Such embodiments, for example, may comprise a final aqueous-based composition that can be applied (e.g., sprayed) onto a portion of a surface or substrate (e.g., inorganic surface).

In accordance with certain embodiments of the invention, the aqueous-based composition may further comprise at least one surfactant, such as an anionic surfactant, cationic surfactant, zwitterionic surfactant, or any combination thereof.

The methods, in accordance with certain embodiments of the invention, comprise

applying an aqueous-based composition as described and disclosed herein to a surface (e.g., an inorganic surface) by one or more means, such as by spraying, brushing, rolling, or combinations thereof. Non-limiting examples of inorganic surfaces include concrete, masonry products, gypsum, concrete blocks, cinder blocks, soft mud bricks, sand lime bricks, drain tiles, ceramic tiles, sandstone, plaster, clay bricks, natural stones and rocks, roofing tiles, calcium silicate bricks, cement articles, slag stones and bricks, stucco, limestone, macadam, marble, grouts, mortar, terrazzo, clinker, pumice, terra, cotta, porcelain, adobe, coral, dolomite, asphalt, and any combination thereof.

In accordance with certain embodiments of the invention, the method may also comprise a step of drying the aqueous-based composition to form a protective hydrophobic layer on the surface (e.g., inorganic surface). In accordance with certain embodiments of the invention, the step of drying may be passive in which the aqueous-based composition is simply allowed to dry. Additionally or alternatively, the drying step may include actively drying the aqueous-based composition by conventional means (e.g., exposure to heat, wind, etc. to promote evaporation of the water from the aqueous-based composition).

In accordance with certain embodiments of the invention, the resulting treated surface (e.g., an inorganic surface) may have or exhibit water repellency having a particularly high level of water exclusion percentage from about 70% to 100%, such as from at least about any of the following: 70, 75, 80, 82, 84, 86, 88, 90, 92 and 94% and/or at most about 100, 99, 98, 97, 96, 95, 94, 93, 92, 91, and 90%. The water exclusion percentage may be determined in accordance with the following procedure and calculation: (a) a first piece of a substrate (e.g., an untreated inorganic substrate) are weighed and dried in an oven at 100° C. until a constant weight is reached. The substrate is then weighed and placed in 1 cm of water for 1 hour, weighed again, and dried in a 100° C. oven until a constant weight is reached. Next or in parallel, a second piece of the same substrate is weighed, soaked in the aqueous-based composition, such as those disclosed herein, for 20 second and then dried, and finally reweighed to provide a treated substrate. The treated substrate is then placed in 1 cm of water for 1 hour and weighed. The percent water exclusion for the treated substrate is calculated in the following manner:

[(weight of water pickup of the untreated substrate−weight of water pickup of the treated substrate)/(weight of the water pickup of the untreated substrate)]*100=percent weight exclusion.

### EXAMPLES

The present disclosure is further illustrated by the following examples, which in no way should be construed as being limiting. That is, the specific features described in the following examples are merely illustrative and not limiting.

### Example 1—Transesterification of Methyltrimethoxysilane

A two liter, three necked flask equipped with a condenser, stirrer, thermometer, and distillation head was charged with (i) 136 grams of methyltrimethoxysilane, (ii) 186 grams of monoehtylene glycol, and (iii) 0.6 grams of tetra isopropyltitanate was added into the mixture to facilitate a transesterification reaction to provide a non-ionic water soluble organosilane. This mixture was heated to 120° C. for two hours, during which 92 grams of methanol were recovered after which the reaction was deemed complete. The resulting product was completely soluble in water up to at least 10% by weight of the solution.

### Example 2—Transesterification of Propyltrimethoxysilane

A two liter, three necked flask equipped with a condenser, stirrer, thermometer, and distillation head was charged with (i) 164 grams of methyltrimethoxysilane, (ii) 186 grams of monoehtylene glycol, and (iii) 0.6 grams of tetra isopropyltitanate was added into the mixture to facilitate a transesterification reaction to provide a non-ionic water soluble organosilane. This mixture was heated to 120° C. for two hours, during which 95 grams of methanol were recovered after which the reaction was deemed complete. The resultant product was only dispersible in water at low concentrations.

### Example 3—Blend of Transesterified Silanes

A two liter, three necked flask equipped with a condenser, stirrer, thermometer, and distillation head was charged with (i) 300 grams of Example 1 and (ii) 30 grams of Example 2 followed by stirring for two hours to ensure homogenous blending. 1% of formic acid by weight was added to the mixture. The resulting blend was noted to disperse well in water and form a stable solution.

### Example 4—Blend of Transesterified Silanes with Traditional Silane

A two liter, three necked flask equipped with a condenser, stirrer, thermometer, and distillation head was charged with (i) 300 grams of Example 1 and (ii) 30 grams of propyltrimethoxysilane (PTMO) followed by stirring for two hours to ensure homogenous blending. 1% of formic acid by weight was added to the mixture. The resulting blend was noted to disperse well in water and form a stable solution.

### Example 5—Blend of Transesterified Silanes with Ionic Organosilane

A two liter, three necked flask equipped with a condenser, stirrer, thermometer, and distillation head was charged with (i) 210 grams of Example 2 and (ii) 90 grams of Dimethyloctadecyl(3-trimethoxysilylpropyl)ammonium chloride followed by stirring for two hours to ensure homogenous blending. 1% of formic acid by weight was added to the mixture. The resulting blend was noted to disperse well in water and form a stable solution.

### Example 6—Silane Cohydrolysed with TEOS and then Transesterfied

A two liter, three necked flask equipped with a condenser, stirrer, thermometer, and distillation head was charged with 164 grams of methyltrimethoxysilane and 208 grams of Tetraethylorthosilicate (TEOS). 18 grams of water were subsequently added into the reaction vessel. The reactants were refluxed at 80° C. for two hours to produce a cohydrolysate product. Free methanol and ethanol generated was subsequently distilled. Subsequently, 0.6 grams of tetra isopropyltitanate and 310 grams of monoehtylene glycol were added into the mixture to facilitate a transesterification reaction to provide a non-ionic water dispersible organosilane. This mixture was heated to 120° C. for two hours, during which free methanol was distilled.

These and other modifications and variations to the invention may be practiced by those of ordinary skill in the art without departing from the spirit and scope of the invention, which is more particularly set forth in the appended claims. In addition, it should be understood that aspects of the various embodiments may be interchanged in whole or in part. Furthermore, those of ordinary skill in the art will appreciate that the foregoing description is by way of example only, and it is not intended to limit the invention as further described in such appended claims. Therefore, the spirit and scope of the appended claims should not be limited to the exemplary description of the versions contained herein.

1. A method of treating an inorganic surface, comprising: applying an aqueous-based composition to the inorganic surface, the aqueous-based composition comprising at least one transesterified alkoxy silane.

2. The method of claim 1, wherein the at least one transesterified alkoxy silane comprises a structure according to the formula: 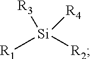
wherein
R₁ comprises a substituted or non-substituted hydrocarbon radical;
R₂ comprises a first hydroxy-containing alkoxy radical;
R₃ comprises an alkoxy radical or a second hydroxy-containing alkoxy radical; and
R₄ comprises an alkoxy radical or a third hydroxy-containing alkoxy radical.

3. The method of claim 2, wherein the first hydroxy-containing alkoxy radical, the second hydroxy-containing alkoxy radical, and the third hydroxy-containing alkoxy radical are the same.

4. The method of claim 2, wherein the first hydroxy-containing alkoxy radical is different than at least the second hydroxy-containing alkoxy radical.

5. The method of claim 2, wherein R₁ comprises an alkyl radical.

6. The method of claim 5, wherein the alkyl radical comprises a linear alkyl radical, a branched alkyl radical, or a cycloalkyl radical including from one to thirty carbon atoms.

7. The method of claim 2, wherein R₁ comprises a substituted hydrocarbon radical having one or more of a halide atom, a nitrogen atom, or an oxygen atom.

8. The method of claim 2, wherein at least the first hydroxy-containing alkoxy radical comprises —(OCH₂CH₂)ₐOH where ‘a’ has a value of 1 through 10, —[OC₃H₆]_{b}OH where ‘b’ has a value of one through ten, or [C₃H₇O₃].

9. The method of claim 2, wherein the at least one transesterified alkoxy silane comprises the first hydroxy-containing alkoxy radical and the second hydroxy-containing alkoxy radical, and wherein the first hydroxy-containing alkoxy radical and the second hydroxy-containing alkoxy radical each independently comprise —(OCH₂CH₂)ₐOH where ‘a’ has a value of 1 through 10, —OC₃H₆]_{b}OH where ‘b’ has a value of 1 through 10, or [C₃H₇O₃].

10. The method of claim 1, wherein the at least one at least one transesterified alkoxy silane comprises about 0.01 to about 20 weight percent of the aqueous-based solution.

11. The method of claim 1, wherein the at least one transesterified alkoxy silane comprises a solubility in water of at least about 5 grams per Liter of water at a temperature of 20° C., such as at least about 10 g/L, at least about 20 g/L, or at least about 50 g/L.

12. The method of claim 1, wherein the aqueous-based solution may further comprise at least one water soluble non-ionic organosilane.

13. The method of claim 12, wherein the at least one water soluble non-ionic organosilane comprises an amino-functional silane or a bis-aminofunctional silane.

14. The method of claim 13, wherein the amino-functional silane comprises N-(2-aminoethyl)-3-aminopropyltrimethoxysilane, N-minoethylaminomethyl)phenyltrimethoxysilane, N-(2-aminoethyl)-3-aminopropyltris(2-ethylhexoxy)-silane, 3-aminopropyltrimethoxysilane, trimethoxysilyl-propyldiethylenetriamine, bis(2-hydroxyethyl)-3-aminopropyltrimethoxysilane, 2-methacryloxyethyldimethyl-[3-trimethoxysilylpropyl]ammonium chloride, or any combination thereof.

15. The method of claim 12, wherein the at least one water soluble non-ionic organosilane comprises a structure according to the following formula:
A₍₄₋ₙ₎SiYₙ,
wherein, ‘A’ comprises a monovalent organic radical, ‘Y’ comprises a hydrolyzable radical, and n is 1, 2, or 3.

16. The method of claim 15, wherein ‘A’ comprises an alkyl or aryl radical.

17. The method of claim 15, wherein ‘Y’ comprises acetoxy radicals, alkoxy radicals with 1 to 6 carbon atoms.

18. The method of claim 12, wherein a first weight ratio between the at least one transesterified alkoxy silane to the at least one water soluble non-ionic organosilane calculated on a dry basis comprises from about 50:1 to about 1:1.

19. The method of claim 1, wherein the aqueous-based composition further comprises at least one ionic organosilicon compound comprising a cationic organosilicon compound.

20. The method of claim 19, wherein the cationic organosilicon compound comprises a structure according to the formula: 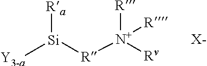
wherein
Y is an alkoxy radical with 1 to 6 carbon atoms; ‘a’ has a value of zero; R″ is propylene; R″ is methyl or ethyl; R″″ and R^{v} are identical or different alkyl groups containing from one to twenty-two carbon atoms, wherein at least one of R′″ and R″″ is larger is larger than eight carbon atoms; and X is a halide, acetate, or tosylate.

21. The method of claim 19, wherein the cationic organosilicon compound comprises 3-(trimethoxysilyl)propyldimethyloctadecyl ammonium chloride, 3-trimethoxysilyl)propylmethyldidecyl ammonium chloride, or 3-(trimethoxysilyl)propyldimethylhexadecyl ammonium chloride.

22. The method of claim 19, wherein the aqueous-based composition comprises a second weight ratio between the at least one transesterified alkoxy silane to the at least one ionic organosilicon compound comprising from about 98:2 to about 2:98.

23. The method of claim 1, wherein the aqueous-based composition comprises an aqueous solution or aqueous dispersion.

24. The method of claim 1, wherein the aqueous-based composition comprises less than 10% by weight of an organic solvent.

25. The method of claim 1, wherein the aqueous-based composition is devoid of an organic solvent.

26. The method of claim 1, wherein the at least one transesterified alkoxy silane is present as a component within a hydrosylate product formed with one or more silicon atom-containing compound.

27. The method of claim 1, wherein the sum of the at least one transesterified alkoxy silane, the at least one water soluble non-ionic organosilane if present, and the at least one ionic organosilicon compound if present comprises from about 5% to about 100% dissolved and/or suspended solids by weight.

28. The method of claim 1, wherein the sum of the at least one transesterified alkoxy silane, the at least one water soluble non-ionic organosilane if present, and the at least one ionic organosilicon compound if present comprises from about 0.1% to about 10% dissolved and/or suspended solids by weight.

29. The method of claim 1, wherein the aqueous-based composition further comprises at least one surfactant.

30. The method of claim 29, wherein the at least one surfactant comprises an anionic surfactant, cationic surfactant, zwitterionic surfactant, non-ionic surfactant or any combination thereof

31. The method of claim 1, wherein applying an aqueous-based composition to the inorganic surface comprises at least one of spraying, brushing, or rolling the aqueous solution onto the inorganic surface.

32. The method according to claim 1; wherein the inorganic surface comprises one or more of concrete, masonry products, gypsum, concrete blocks, cinder blocks, soft mud bricks, sand lime bricks, drain tiles, ceramic tiles, sandstone, plaster, clay bricks, natural stones and rocks, roofing tiles, calcium silicate bricks, cement articles, slag stones and bricks, stucco, limestone, macadam, marble, grouts, mortar, terrazzo, clinker, pumice, terra, cotta, porcelain, adobe, coral, dolomite and asphalt.

33. The method of claim 1, further comprising allowing the aqueous-based composition to dry and form a protective hydrophobic layer on the inorganic surface.

34. The method of claim 33, wherein the inorganic surface exhibits a water exclusion percentage from about 80 to about 100%.
